(19) United States
(12) Patent Application Publication
(10) Pub. No.: US 2021/0086132 A1
(43) Pub. Date: Mar. 25, 2021

(54) LED PANEL FOR FLUIDS FILTERING ELEMENTS, IN PARTICULAR AIR

(71) Applicant: ATELLANI LLC, The Woodlands, TX (US)

(72) Inventor: Maurizio Virginio MARANGHI, The Woodlands, TX (US)

(21) Appl. No.: 16/760,352

(22) PCT Filed: Nov. 14, 2018
(86) PCT No.: PCT/IB2018/058949

§ 371 Date: Apr. 29, 2020

(30) Foreign Application Priority Data
Nov. 14, 2017 (IT) 202017000129711

(51) Int. Cl. B01D 53/88; B01D 53/00; B01D 53/86

(52) U.S. Cl. CPC B01D 53/885; B01D 53/007; B01D 2258/06; B01D 2259/804; B01D 53/8678

(57) ABSTRACT

An LED panel for filtering elements for fluids, in particular air, comprising a supporting element having a main lying surface and supporting a plurality of LEDs. The LED the panel also comprises electrical connection means for the connection of the LEDs to an electricity supply source. The supporting element has a grid-shaped configuration having a plurality of through openings configured to allow the passage of a flow of the fluid through the main lying surface of the LED panel.

### TECHNICAL FIELD

This invention relates to an LED panel for filtering elements for fluids, in particular air, a filtering module comprising the LED panel and a device for filtering air comprising at least one filtering module.

The quality of the air we breath is a recurring theme in studies regarding the quality of life of the population.

This problem adopts particularly evident connotations in particularly industrialised urban conglomerates, but also in towns in which the high number of the motor vehicles circulating leads to a high level of pollution, the well-known “smog”.

Many research studies have shown that the level of pollutants which accumulates in a closed space can be equal to, if not even greater, than that present in the outside environment.

The substances most commonly present in these environments include nitric oxides (NOx) and volatile organic compounds (VOCs), which can also have originated from commonly used household objects, such as: cleaning products, deodorants, air conditioning systems and interior decor. The increasingly greater attention paid to the quality of living conditions and the consequent interest in the improvement of the conditions in rooms both in homes and at work has led to the development of filtering systems which are able to remove, or at least make innocuous, the substances present in the air which are harmful for human health.

### BACKGROUND ART

In particular, it is known that photocatalytic compounds are able, in the presence of oxygen and water, to deteriorate and oxidise efficiently the above-mentioned polluting compounds present in the air.

For example, titanium dioxide, in the presence of UV radiation, is able to destroy by photocatalytic means the polluting substances, degrading them to water and C02, or mineralising them to non-toxic substances.

This feature has resulted in the chemical compound being particularly used in the sector for manufacturing air filters, as it is able to significantly improve the quality of the air breathed in domestic and work environments. In light of this, various types of filters have been developed which base their operation on the photocatalytic principles mentioned above.

In particular, these devices have a filtering element which mainly comprises one of the above-mentioned materials such as, for example, titanium dioxide, and a radiant source such as, for example, LEDs, configured for carrying out the photocatalytic process which allows the purification of the air.

One of the most common drawbacks of the prior art is linked to the free circulation of the fluid to be purified inside the filtering module.

More specifically, the supports for the radiant sources generate an obstruction to the fluid flow, resulting in recirculation phenomena and limiting the operation of the panel to efficiencies which are less than those which can be reached.

This results in an increase in costs for maintaining the filter in energy terms, and therefore also at an economic level, as well having an air cleaning level which is well beneath the levels which can be obtained.

### SUMMARY OF THE INVENTION

For this reason, the aim of this invention is to provide an LED panel for filtering elements for fluids which overcomes the above-mentioned drawbacks of the prior art.

More specifically, the aim of the invention is to provide an LED panel for filtering elements for fluids, in particular air, which allows the circulation of the fluid inside the filtering module generating the minimum obstruction to the flow of circulating fluid.

The aim is achieved by an LED panel for filtering elements for fluids, in particular air, according to the invention, as characterised in one or more of the appended claims.

A further aim of the invention is to provide a filtering module comprising at least one LED panel according to the invention.

Yet another aim is to provide an air filtering device comprising at least one LED panel.

### BRIEF DESCRIPTION OF THE DRAWINGS

The technical features of the invention, with reference to the above aim, are clearly described in the claims below and its advantages are apparent from the detailed description which follows, with reference to the accompanying drawings which illustrate a non-limiting example embodiment of the invention and in which:

FIG. 1 is a first top view of an LED panel for filtering elements for fluids according to the invention;

FIG. 2 is a first perspective view of a filtering module;

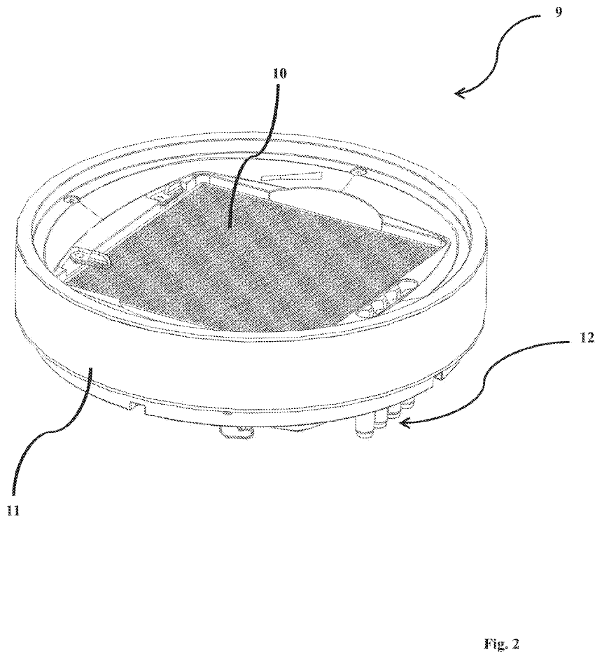

FIG. 3 is a second perspective view of the filtering module of FIG. 2;

FIG. 4 is a cross section view, in a vertical plane, of the filtering module of FIG. 2;

FIG. 5 is an enlarged cross section of a detail of the filtering module of FIG. 2;

FIG. 6 is a cross section view, in a vertical plane, of two filtering modules shown in FIG. 2 in a mutually stacked and coupled configuration;

FIG. 7 shows a air filtering device for air according to the invention and

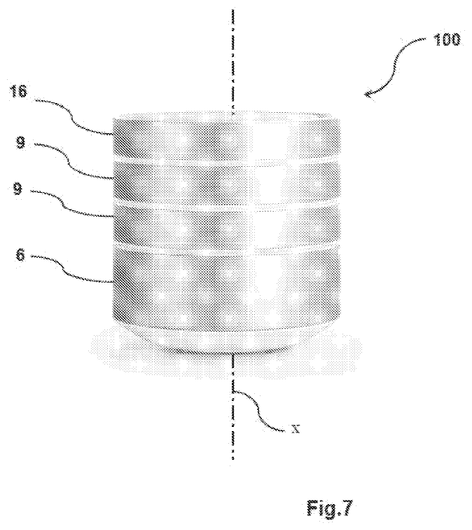

FIG. 8 shows a filtering module according to the invention.

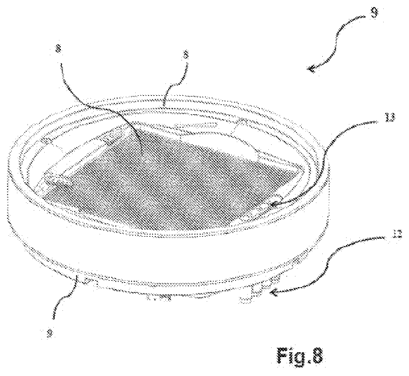

### DETAILED DESCRIPTION OF PREFERRED EMBODIMENTS OF THE INVENTION

With reference to the accompanying drawings, the numeral 1 denotes in its entirety an LED panel for filtering elements for fluids, in particular air, hereinafter referred to as LED panel 1, in accordance with a preferred embodiment of the invention.

The LED panel 1 comprises a supporting element 2 on which is applied a plurality of LEDs 3 and on which there are electrical connection means 4 for powering the LEDs.

The supporting element 2 has a main lying surface. Preferably, the lying surface is flat or substantially flat.

In accordance with different embodiments not shown in the drawings, the supporting element 2 may have a different shape, such as, for example, concave or convex, without altering the inventive concept of the invention. The supporting element 2 also has a plurality of through openings 2a configured to allow the passage of a flow of air to be filtered.

In short, the supporting element 2 has the shape of a grid in such a way as to allow the passage of the air flow through the main lying surface.

As shown in the accompanying drawings, the supporting element 2 also has a substantially rectangular shape.

The supporting element 2 advantageously has ten openings 2a, with an essentially rectangular shape and equal dimensions.

In particular, the openings are located according to an arrangement with five rows and two columns.

In accordance with different embodiments not shown in the drawings, the shape of the supporting element 2 and/or of the openings 2a may be different.

Moreover, the openings 2a on the element 2 can adopt different positions and distributions.

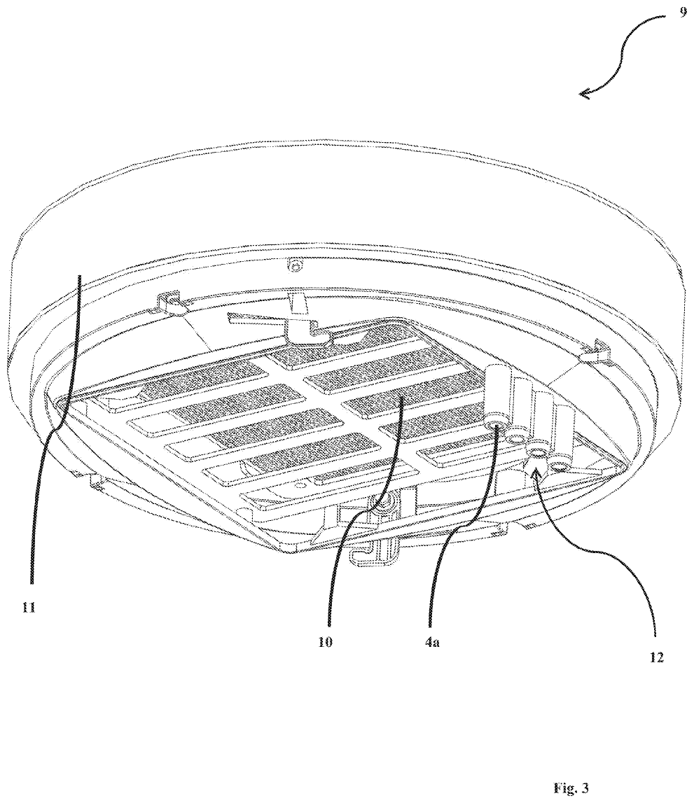

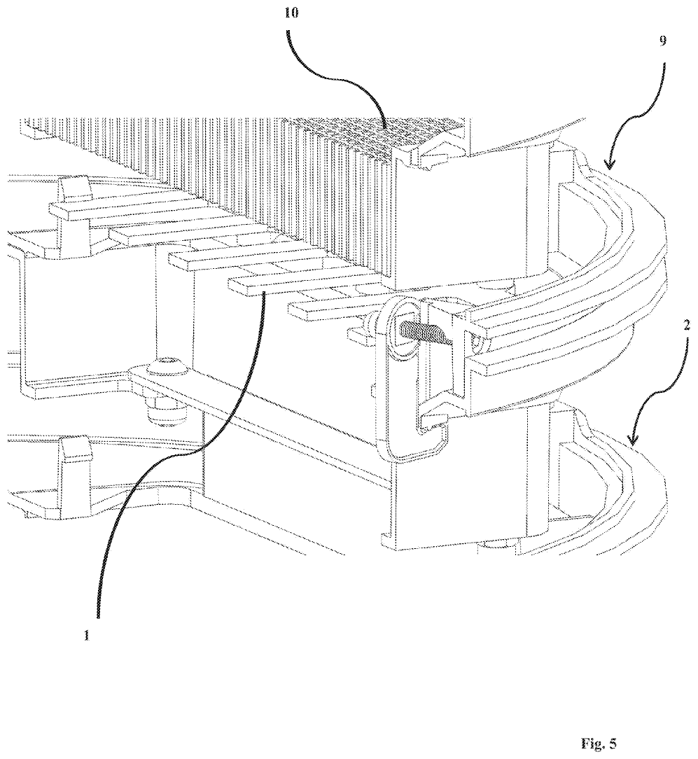

Preferably, the supporting element 2 comprises anchoring means 5, such as, for example, through holes, sockets or the like, designed to allow the anchoring of the LED panel 1 to a load-bearing structure 11 as illustrated in FIGS. 3 and 5.

Still more preferably, the anchoring means 5 are positioned in a peripheral position of the supporting element 2, such as, for example, against an edge, in such a way as not to interfere with the flow of air.

According a preferred embodiment, the supporting element 2 is defined by a wafer suitably shaped in such a way as to have the through openings 2a described above.

The wafer is made from substantially isolating material, preferably Vetronite or Fiberglass, and it is at least partially covered by a conductive metal coating, so as to give particular electrical properties to the supporting element 2.

In other words, the supporting element 2 is a printed circuit and supports a plurality of LEDs (Light Emitting Diodes) 3, configured for emitting radiation in such a way as to take part in a photocatalysis process which is fundamental for purifying the air.

According to the preferred embodiment of the invention, the plurality of LEDs 3 comprises 42 LEDs integrated directly on the printed circuit.

The LEDs are specially arranged in such a way as to guarantee an almost uniform irradiance for the air flow which passes through the relative main lying surface of the supporting element 2.

In particular, the LEDs 3a are located substantially according to an arrangement with six lines and seven columns.

In accordance with different embodiments, the quantity of the LEDs 3a comprised in the plurality of LEDs 3 and their positioning on the supporting element 2, may adopt different solutions from those previously indicated, for example, the LEDs can be positioned on both surfaces of the supporting element 2.

With reference to the electrical connection means 4, they are preferably positioned on a peripheral portion, for example against a lateral edge, of the supporting element 2 in such a way as to limit the overall dimensions with respect to the air flow which passes through the openings 2a of the LED panel 1.

Still more preferably, the electrical connection means 4 are positioned adjacent to a side of the supporting element 2, that is, in a perimeter strip of the supporting element 2.

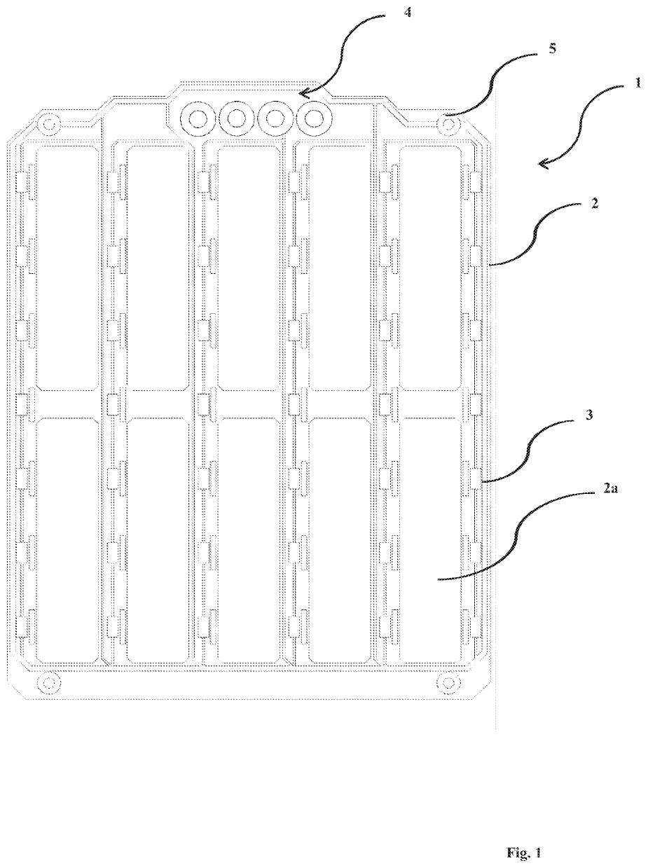

As shown in FIG. 1, the electrical connection means 4 comprise connectors integrated in the supporting element, in particular in the printed circuit.

Advantageously, the electricity supply reaches the elements positioned on the printed circuit without the use of additional wires which would limit the free flow of air through the LED panel 1.

Preferably, the integrated connectors have sliding electrical contacts.

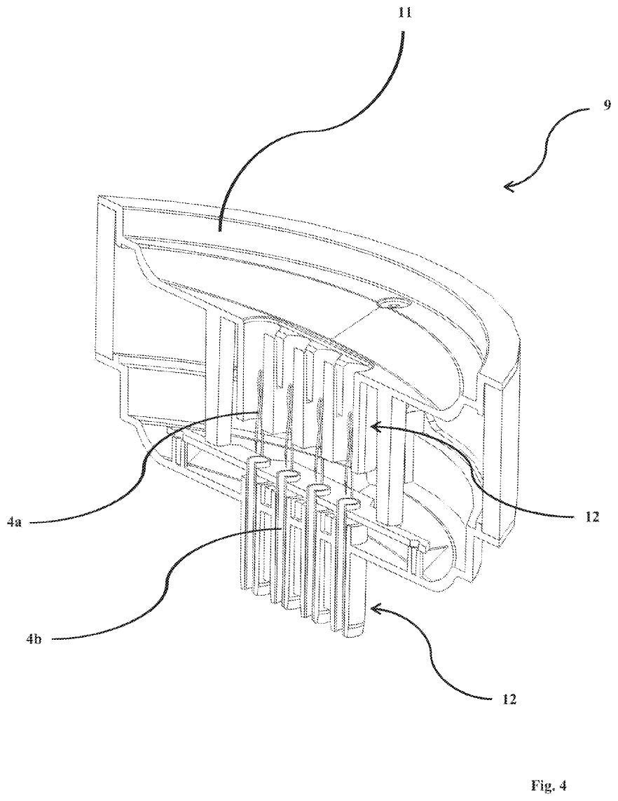

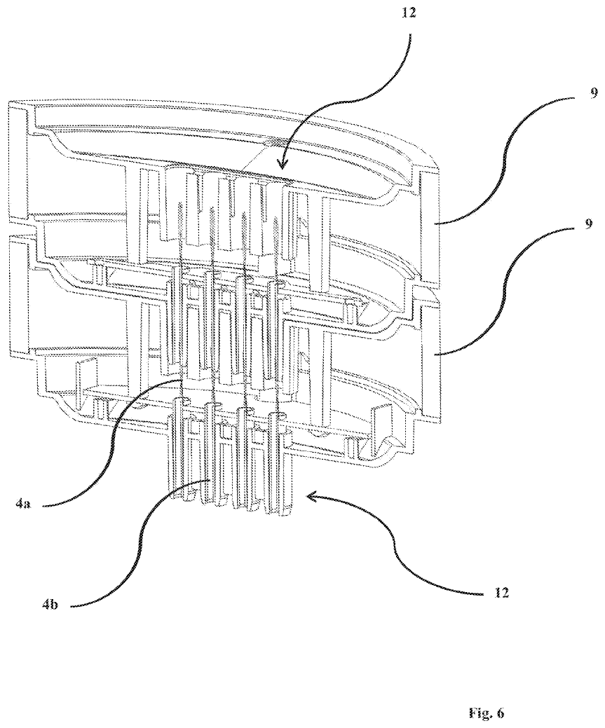

In accordance with the embodiment illustrated in FIGS. 4 and 6, the connectors comprise a first group of electrical contacts positioned on one side of the supporting element 2 and a second group of electrical contacts positioned on the opposite side of the supporting element 2. More specifically, the first group of electrical contacts has male type electrical contacts 4a and the second group of electrical contacts has female type electrical contacts 4b.

Preferably, the male type electrical contacts 4a are defined by the metal wires defining at least one winding in such a way as to have a predetermined transversal flexibility and/or rigidity. In this way the male type electrical contacts 4a can be coupled, preferably can be inserted, with respective female type electrical contacts 4b of another identical supporting element 2, matching at least partly to the latter and guaranteeing a continuous electrical coupling.

The female type electrical contacts 4b comprise tubular elements at least partly made of metal material and configured to house, in a sliding contact fashion, respective male type electrical contacts 4a of another identical supporting element 2. More specifically, the shape of the electrical contacts described above allows the male type electrical contacts 4a of be inserted and removed with respect to corresponding female type tubular elements.

According to the preferred embodiment of the invention, the male and female type electrical contacts are of a reciprocally compatible type.

More specifically, the LED panel 1 has four male type electrical contacts 4a and four respective female type electrical contacts 4b.

These male and female type electrical contacts can be engaged with each other by mutual insertion along a stacking direction. In this way, the electrical contacts of the male and female type are suitable for allowing a modular coupling between LED panels 1 which are identical to each other by stacking in a column.

Advantageously, for a same supporting element 2 the male and female type electrical contacts are positioned on opposite surfaces of the supporting element 2 in an identical position, that is to say, aligned or superposed, in such a way that there is no need to make uninterrupted wiring along the surface of the supporting element 2.

According to another aspect, the invention comprises a filtering module 9 configured for purifying a flow of air.

More specifically, the filtering module comprises an LED panel 1 in accordance with at least one of the embodiments described above, a filtering element 10 and a load-bearing structure 11 configured to support the LED panel 1 and the filtering element 10.

According to the accompanying drawings, the load-bearing structure 11 has a substantially hollow cylindrical shape in such a way as to form an inner conduit for the passage of a flow of fluid, preferably air. The load-bearing structure 11 also comprises an internal housing with a substantially square shape configured to house the LED panel 1 and the filtering element 10, preferably in a stacked position.

In other words, the filtering element 10 is mounted on the load-bearing structure 11 in a position adjacent to the LED panel 1.

The filtering element 10 is also configured for acting in conjunction with the LED panel 1 so as to purify the flow of air passing inside the filtering module 9 according to a photocatalytic operating principle.

The filtering module 9 is mechanically and/or electrically connectable to adjacent modules, preferably identical filtering modules, using the electrical connection means 4 described above.

In accordance with the embodiment shown in the drawings, the filtering module 9 also comprises mechanical connection means 12 configured for coupling filtering modules, preferably identical.

More specifically, the mechanical connection means comprise shape couplings of the male and female type which can be engaged with each other by mutual insertion along the above-mentioned stacking direction.

The mechanical connectors are grouped in a single pack of four connectors located on a side of the load-bearing structure 11.

In particular, the mechanical connectors are configured to house the electrical contacts described above in such a way as to make a simultaneous mechanical and electrical coupling of two filtering modules 9.

According to an embodiment not shown in the drawings, the supporting element 2 also supports an adjustment module (not shown in the drawings) configured for adjusting the switching ON/OFF of the plurality of LEDs 3 and connected to the electrical connection means 4.

A further aspect of the invention relates to an air filtering device 100 comprising:
a base module 6 which can be connected to a source of electrical power supply and comprising at least one fan 7 for moving air;
   at least one filtering module 9 which can be connected to the base module 6 and housing at least one air filtering element 8 comprising a photocatalytic filter;
an end module 16, comprising electrical means for switching ON the air filtering device 1.

The base module 6 and/or filtering module 9 have fluid dynamic connecting means defining a single conduit for passage of air for placing in fluid communication the fan 7 and the filtering element 8; and wherein the base module 6 and the filtering module 9 and the end module 16 comprise respective mechanical connections 12, 13 configured to form a stable mechanical connection between the modules.

Moreover, the base module 6, the filtering module 9 and the end module 16 have respective electrical connections 4a, 4b for transmitting an electrical power supply between the modules 6, 9, 16.

The electrical connections 4a, 4b and the mechanical connections 12, 13 being configured in such a way that the mechanical coupling between the mechanical connections 12, 13 of the modules 6, 9, 16 automatically also determines a simultaneous engagement between the electrical connections 4a, 4b.

Advantageously, the base module 6, at least one filtering module 9 and the end module 16 are stackable defining, an air filtering device 100 delimited by a base module 6 and an end module 16 between which is interposed at least one filtering module 9.

Advantageously, moreover, the filtering module 15 of the filtering device 100 comprises at least one LED panel 1 as described in the invention.

It should be noted, therefore, that the invention achieves the set aims thanks to an LED panel for filtering elements for fluids with a configuration in the form of a grid and having a plurality of through openings configured to allow the circulation of the fluid inside the filtering module generating the minimum obstruction to the flow of circulating fluid.

Moreover, the use of a printed circuit allows the overall dimensions inside the filtering module to be limited.

Moreover, the use of a modular architecture makes it possible to modify the number the filtering elements on the basis of the size of the room which contains the air to be purified.

1. An LED panel for filtering elements for fluids, in particular air, comprising a supporting element having a main lying surface and supporting a plurality of LEDs, and electrical connection means for connection of the LEDs to an electricity supply source,
wherein the supporting element has a grid-shaped configuration having a plurality of through openings configured to allow the passage of a flow of the fluid through the main lying surface.

2. The LED panel according to claim 1, wherein the supporting element has a substantially flat two-dimensional shape.

3. The LED panel according to claim 1, wherein the supporting element has plate-like configuration equipped with through openings.

4. The LED panel according to claim 3, wherein the supporting element has square or rectangular and is equipped with a two-dimensional series of through openings with a rectangular or square shape.

5. The LED panel according to claim 1, wherein the supporting element is defined by a wafer or printed circuit shaped in such a way as to have the through openings.

6. The LED panel according to claim 5, wherein the LEDs are directly integrated on the printed circuit.

7. The LED panel according to claim 1, wherein the electrical connection means comprise connectors integrated in the supporting element, in particular in the printed circuit.

8. The LED panel according to claim 7, wherein the connectors comprise sliding electrical contacts.

9. The LED panel according to claim 7, wherein the connectors comprise a first group of electrical contacts positioned on a side of the supporting element and a second group of electrical contacts located on the opposite side of the supporting element.

10. The LED panel according to claim 9, wherein the first group of electrical contacts has male type electrical contacts and wherein the second group of electrical contacts has female type electrical contacts.

11. The LED panel according to claim 10, wherein the male and female type electrical contacts are mutually compatible for allowing a modular coupling between identical LED panels, in particular connected to each other by stacking in a column.

12. The LED panel according to claim 10, wherein the male type electrical contacts are defined by the metal wires defining at least one winding in such a way as to have a predetermined transversal flexibility and/or rigidity.

13. The LED panel according to claim 10, wherein the female type electrical contacts comprise tubular elements at least partly made of metal material and in particular configured to house, in a sliding contact fashion, respective male type connectors.

14. The LED panel according to claim 1, wherein the electrical connection means are positioned on a peripheral portion, preferably against a lateral edge, of the supporting element.

15. The LED panel according to claim 1, wherein the supporting element comprises means for anchoring the LED panel to a load-bearing structure.

16. The LED panel according to claim 1, wherein the supporting element also supports an adjustment module configured for adjusting the switching ON/OFF of the plurality of LEDs, and a power supply circuit powering the plurality of LEDs, and the adjustment module and powered by the electrical connection means.

17. A filtering module, comprising:
a load-bearing structure;
an LED panel according to claim 1, mounted on the load-bearing structure;
a filtering element, mounted on the load-bearing structure adjacent to the LED panel and acting in conjunction with the LED panel according to a photocatalytic operating principle; wherein the filtering module is mechanically and/or electrically connectable to adjacent modules, in particular identical filtering modules, by means of the electrical connection means.

18. An air filtering device comprising:
a base module which can be connected to a source of electrical power supply and comprising at least one fan for moving air;
at least one filtering module according to claim 17, which can be connected to the base module and which houses at least one air filtering element comprising a photocatalytic filter; an end module comprising electrical means for switching ON the air filtering device;
wherein the base module and/or filtering module have fluid dynamic connecting means defining a single conduit for passage of air for placing in fluid communication the fan and the filtering element; and
wherein the base module and the filtering module and the end module comprise respective mechanical connections configured to form a stable mechanical connection between the modules;
the base module, filtering module and end module have respective electrical connections for transmitting an electrical power supply between the modules, the electrical connections and mechanical connections being configured in such a way that the mechanical coupling between the mechanical connections of the modules also automatically determines a simultaneous engagement between the electrical connections characterized in that the base module, at least one filtering module and the end module are stackable, defining an air filtering device delimited by a base module and by an end module between which is interposed the at least one filtering module and characterized in that the at least one filtering module comprises at least an LED panel.
